(19) United States
(12) Patent Application Publication
(10) Pub. No.: US 2024/0087362 A1
(43) Pub. Date: Mar. 14, 2024

(54) Mobile Digital Assistant for Law Enforcement Personnel

(71) Applicant: Anthony Macciola, Lake Forest, CA (US)

(72) Inventor: Anthony Macciola, Lake Forest, CA (US)

(21) Appl. No.: 17/940,416

(22) Filed: Sep. 8, 2022

(51) Int. Cl. G06V 40/16; G06V 30/14; G06V 30/41

(52) U.S. Cl. CPC G06V 40/172; G06V 30/14; G06V 30/41

(57) ABSTRACT

An example operation includes receiving image data from an input device; analyzing the image data to identify one or more alphanumeric strings; forwarding the one or more alphanumeric strings to an external database, along with a status verification request; and receiving a status verification message from the external database in response to the status verification request, the status verification message indicative of a status corresponding to the alphanumeric string.

### BACKGROUND

The present invention relates to a mobile digital assistant for police and law enforcement officers. More specifically, the mobile digital assistant is equipped with sensors and artificial intelligence to gather information from civilians during a traffic stop or other law enforcement action.

Enforcing traffic regulations represents the most common form of contact the public has with law enforcement personnel. A typical traffic stop requires an officer to leave their police vehicle several times to speak with the driver. The officer obtains driver's license, registration and insurance documents, and then carries these documents back to the police vehicle to run database checks on the driver. After the database checks are completed, the officer returns the documents to the driver. At this time, the officer may present the driver with a traffic violation ticket. Such a routine traffic stop can turn deadly for an officer if a passing vehicle accidentally swerves and hits the officer while the officer is outside of his law enforcement vehicle. According to statistics collected by the FBI, 22 law enforcement officers were killed outside their vehicles during traffic pursuits and traffic stops between 2006 and 2015. Accordingly, what is needed is an improved mechanism that permits law enforcement personnel to expeditiously collect information from drivers while reducing the amount of time that the officer spends outside of their police vehicle.

### SUMMARY

One example embodiment provides a method that includes receiving image data from an input device, analyzing the image data to identify one or more alphanumeric strings, forwarding the one or more identified alphanumeric strings to an external database along with a status verification request, and receiving a status verification message from the external database in response to the status verification request, the status verification message indicative of a status corresponding to the alphanumeric string.

Another example embodiment provides a method that includes receiving image data from an input device, analyzing the image data to identify a first facial image, associating the first facial image with an alphanumeric string, retrieving a second facial image corresponding to the alphanumeric string from an external database, and comparing the first facial image to the second facial image to determine whether or not the first facial image and the second facial image are both of a single individual.

Another example embodiment provides a system that includes a memory communicably coupled to a processor, wherein the processor is configured to receive image data from an input device, analyze the image data to identify one or more alphanumeric strings, forward the one or more identified alphanumeric strings to an external database along with a status verification request, and receive a status verification message from the external database in response to the status verification request, the status verification message indicative of a status corresponding to the alphanumeric string.

Another example embodiment provides a system that includes a memory communicably coupled to a processor, wherein the processor is configured to receive image data from an input device, analyze the image data to identify a first facial image, associate the first facial image with an alphanumeric string, retrieve a second facial image corresponding to the alphanumeric string from an external database, and compare the first facial image to the second facial image to determine whether or not the first facial image and the second facial image are both of a single individual.

A further example embodiment provides a computer readable storage medium comprising instructions that, when read by a processor, cause the processor to perform receiving image data from an input device, analyzing the image data to identify one or more alphanumeric strings, forwarding the one or more identified alphanumeric strings to an external database along with a status verification request, and receiving a status verification message from the external database in response to the status verification request, the status verification message indicative of a status corresponding to the alphanumeric string.

Another example embodiment provides a computer readable storage medium comprising instructions that, when read by a processor, cause the processor to perform receiving image data from an input device, analyzing the image data to identify a first facial image, associating the first facial image with an alphanumeric string, retrieving a second facial image corresponding to the alphanumeric string from an external database, and comparing the first facial image to the second facial image to determine whether or not the first facial image and the second facial image are both of a single individual.

### BRIEF DESCRIPTION OF THE DRAWINGS

FIG. 1 illustrates an example system diagram, according to example embodiments.

FIG. 2 illustrates a flow diagram, according to example embodiments.

FIG. 3 illustrates another flow diagram, according to example embodiments.

FIG. 4 illustrates a machine learning transport network diagram, according to example embodiments.

FIG. 5 illustrates an example system that supports one or more of the example embodiments.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, computer readable storage medium and system, as represented in the attached figures, is not intended to limit the scope of the application as claimed but is merely representative of selected embodiments. Multiple embodiments depicted herein are not intended to limit the scope of the solution. The computer-readable storage medium may be a non-transitory computer readable medium or a non-transitory computer readable storage medium.

Communications between certain entities, such as external databases, input devices, mobile devices, remote servers, and local computing devices (e.g., smartphones, personal computers, embedded computers, etc.) may be sent and/or received, and processed by one or more ‘components’ which may be hardware, firmware, software or a combination thereof. The components may be part of any of these entities or computing devices or certain other computing devices.

The instant features, structures, or characteristics as described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one example. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments. In the diagrams, any connection between elements can permit one-way and/or two-way communication even if the depicted connection is a one-way or two-way arrow.

In addition, while the term “message” may have been used in the description of embodiments, other types of network data, such as, a packet, frame, datagram, etc. may also be used. Furthermore, while certain types of messages and signaling may be depicted in exemplary embodiments, they are not limited to a certain type of message and signaling.

Example embodiments provide methods, systems, components, non-transitory computer readable medium, devices, and/or networks, which provide a mobile digital assistant that is equipped with sensors and artificial intelligence to gather information from civilians during a traffic stop or other law enforcement action. The mobile digital assistant may comprise one or more of a data collection system, a data monitoring system, a verification system, an authorization system and/or a data distribution system. Further embodiments of the instant solution can utilize any of software, an array of sensors, one or more cameras, machine learning functionality, GPS, electronic maps, light detection and ranging (LIDAR) projectors, radar, and/or ultrasonic sensors.

Any of the actions described herein may be performed by one or more processors (such as a microprocessor, a sensor, an Electronic Control Unit (ECU), a head unit, and the like). The one or more processors may communicate with other processors. The one or more processors and the other processors can send data, receive data, and utilize this data to perform one or more of the actions described or depicted herein.

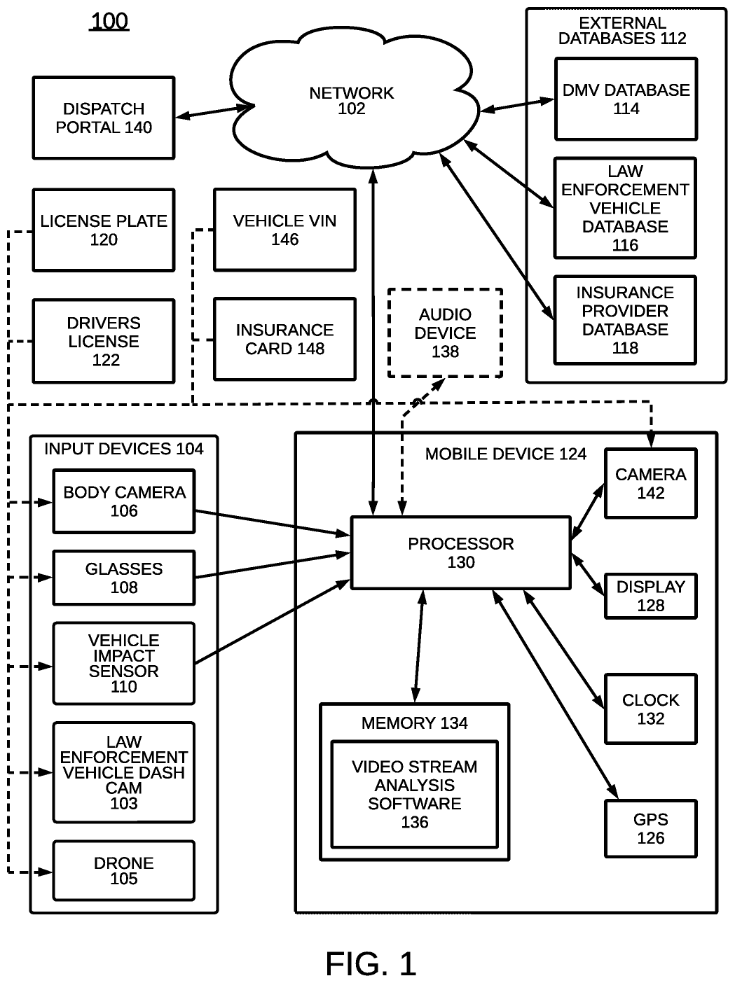

FIG. 1 illustrates a system diagram 100, in one set of embodiments. In some embodiments, the instant solution fully or partially executes in a memory 134 of a processor 130 of a computer associated with a mobile device 124, and/or in a memory of one or more other processors associated with devices and/or entities mentioned herein. In some embodiments, the instant solution executes fully or partially on any processor or server located on any element in the system diagram 100.

In some embodiments, the processor 130 receives image data from one or more input devices 104 over a first communications link comprising one or more of Bluetooth, WiFi, USB, or any of various combinations thereof. The one or more input devices 104 may include one or more of: a body camera 106, a set of glasses 108, a vehicle impact sensor 110, a law enforcement vehicle dash cam 103, a wearable device, a body-worn camera, a remotely-controlled drone 105 capable of streaming video and audio, an infrared camera to detect body heat, or any of various combinations thereof. In some embodiments, the one or more input devices 104 are configured for capturing video and/or audio, and streaming the captured video and/or audio to a mobile device. For example, the one or more input devices 104 can include a pair of embedded, 4-Megapixel, broad-spectrum, low-light pinhole cameras capable of streaming live video and/or audio to the mobile device 124 over a WiFi or Bluetooth wireless communications link, and/or over a tethered USB link. Alternatively or additionally, the image data can be received from a camera 142 on board the mobile device 124.

The processor 130 analyzes the received image data using a video stream analysis software 136 program stored in the memory 134 to identify one or more alphanumeric strings contained within the received image data. For example, the one or more alphanumeric strings may represent any of: a license plate number 120 of a vehicle license plate; a vehicle identification (VIN) 146 number; a name, an address, an expiration date, a birthdate, an eye color, a height, a weight, a hair color, and/or a drivers license number of a driver listed on the drivers license 122; and/or a name, address, and policy number posted on an insurance card 148. In some embodiments, the video stream analysis software 136 includes character recognition software.

The processor 130 forwards the one or more identified alphanumeric strings to one or more external databases 112 over a network 102, along with a status verification request. For example, the one or more external databases 112 may include any of a Department of Motor Vehicles (DMV) database 114, a law enforcement vehicle database 116, and/or an insurance provider database 118. The network 102 may include the Internet, a cellular communications network, a WiFi network, a local-area network (LAN), a wide-area network (WAN), a private communications network, a radio network, a packet network, or any of various combinations thereof. In response to the status verification request, the processor 130 receives a status verification message from at least one of the external databases 112 over the network 102 indicative of a status corresponding to the alphanumeric string. For example, in some cases, the status verification message may indicate that the license plate 120, the drivers license 122, the insurance card 148, or the vehicle VIN 146 is valid. In other cases, the status verification message may indicate that the license plate 120, the drivers license 122, the insurance card 148, or the vehicle VIN 146 is invalid, expired, or suspended.

In some embodiments, the processor 130 receives image data from one or more input devices 104 over the first communications link comprising one or more of Bluetooth, WiFi, USB, or any of various combinations thereof. The input devices 104 may include one or more of the body camera 106, the set of glasses 108, the law enforcement vehicle dash cam 103, the drone 105, and/or the vehicle impact sensor 110. For example, the input devices 104 can include a pair of embedded, 4-Megapixel, broad-spectrum, low-light pinhole cameras capable of streaming live video and/or audio to the mobile device 124 over a WiFi or Bluetooth wireless communications link, and/or over a tethered USB link. Alternatively or additionally, the image data can be received from the camera 142 on board the mobile device 124.

The processor 130 analyzes the received image data using the video stream analysis software 136 program stored in the memory 134 to identify a first facial image. For example, the first facial image may be acquired by the body camera 106, the glasses 108, the law enforcement vehicle dash cam 103, the drone 105, and/or the camera 142 taking a photo of the driver. The first facial image is associated with an alphanumeric string, such as a name, an address, a birthdate, a drivers license 122 number, information from a bar code on the drivers license 122, information from a magnetic stripe on the drivers license 122, a QR (quick response) code on the drivers license 122, other data presented on the drivers license 122, or any of various combinations thereof. The processor 130 retrieves a second facial image corresponding to the alphanumeric string over the network 102 from one or more external databases 112, where the alphanumeric string may represent any of the name, the address, the expiration date, the birthdate, the eye color, the height, the weight, the hair color, and/or the drivers license number of the driver listed on the drivers license 122. Alternatively or additionally, the second facial image may be acquired by the body camera 106, the glasses 108, the law enforcement vehicle dash cam, the drone, and/or the camera 142 taking a photo of the drivers license 122. The processor 130 uses the video stream analysis software 136 to compare the first facial image to the second facial image to determine whether or not the first facial image and the second facial image are both of a single individual and, in fact, depict the same person.

In some embodiments, the memory 134 includes artificial intelligence software and machine vision technology to analyze (for example, in real time) inbound, streaming video and audio from the one or more input devices 104. The processor 130 can identify, decode, analyze, verify, and report on the following artifacts and/or entities:

License Plate 120:

A law enforcement officer equipped with the glasses 108, the body camera 106, the law enforcement vehicle dash cam 103, the drone 105, and/or the camera 142 of the mobile device 124, captures one or more images from the front and/or back of a vehicle. The vehicle can be moving or parked (stationary). The processor 130 automatically detects and decodes the license plate 120 number from an incoming video stream of the one or more input devices 104 and performs a real-time lookup over the network 102 to one or more external databases 112, such as the DMV database, the law enforcement vehicle database 116, the insurance provider database 118, and/or any other pre-configured external database. This capability allows the law enforcement officer to automatically determine a status of a vehicle registration and what, if any, action should be taken. For example, the status of the vehicle registration may include any of: a registration for the vehicle has expired, the license plate 120 has been reported stolen, the license plate 120 is valid, the vehicle bearing the license plate 120 should be a blue 1997 Ford Thunderbird (for example), and/or caution should be exercised when stopping the vehicle. In some embodiments, the status of the license plate 120, and optionally any recommended action, can be returned to the officer through visual cues provided on a display 128 of the mobile device 124, through audio feedback via an internal speaker on the mobile device 124, and/or on an external audio device 130 connected to the mobile device 124 via Bluetooth, FireWire, and/or USB (e.g., ear buds).

Drivers License 122:

A law enforcement officer equipped with the glasses 108, the body camera 106, and/or the camera 142 of the mobile device 124, captures one or more images from the drivers license 122 after they have pulled over the vehicle and engaged the driver. The processor 130 automatically detects and decodes the relevant information on the drivers license 122 from the video stream of the one or more input devices 104 and performs a real-time lookup over the network 102 to one or more external databases 112, such as the DMV database, the law enforcement vehicle database 116, the insurance provider database 118, and/or any other pre-configured external database. This allows the law enforcement officer to automatically determine a status of the drivers license 122 and what, if any, action should be taken (e.g., the status may drivers license 122 is expired, stolen, valid, corresponds to a person of concern, corresponds to a person having an outstanding warrant, corresponds to a known felon, etc.). The status of the drivers license 122, and/or any recommended action, can be returned to the officer either through visual cues provided on the display 128, through audio feedback via the internal speaker of the mobile device 124, and/or on an external audio device 130 connected to the mobile device 124 via Bluetooth, FireWire, and/or USB (e.g., ear buds). In some embodiments, a notification of the status of the drivers license 122 is transmitted by the processor 130 over the network 102 to a dispatch portal 140.

Insurance Card 148:

A law enforcement officer equipped with the glasses 108, the body camera 106, and/or the camera 142 of the mobile device 124, captures one or more images from the insurance card 148 after they have pulled over the vehicle and engaged the driver. The processor 130 automatically detects and decodes the relevant insurance card information from the video stream of the one or more input devices 104, and performs a real-time lookup over the network 102 to one or more external databases 112, such as the DMV database, the law enforcement vehicle database 116, the insurance provider database 118, and/or any other pre-configured external database. This allows the law enforcement officer to automatically determine a status of the driver's insurance policy and what, if any, action should be taken (e.g., the status of the driver's insurance policy is expired, invalid, valid, etc.). The status of the insurance policy and/or any recommended action can be returned to the officer through visual cues provided on the display 128, through audio feedback via the internal speaker of the mobile device 124, and/or on an external audio device 130 connected to the mobile device 124 via Bluetooth, FireWire, and/or USB (e.g., ear buds). In some embodiments, a notification of the status of the insurance card 148 is transmitted by the processor 130 over the network 102 to a dispatch portal 140.

Vehicle VIN 146:

A law enforcement officer equipped with the glasses 108, the body camera 106, and/or the camera 142 of the mobile device 124, captures one or more images of the vehicle VIN 146 through a front windshield of the vehicle, or via the inside of a driver's side front door panel of the vehicle, once they have pulled the vehicle over and are engaging the driver. The processor 130 automatically detects and decodes the vehicle VIN 146 from the video stream of the one or more input devices 104 and performs a real-time lookup over the network 102 to one or more external databases 112, such as the DMV database, the law enforcement vehicle database 116, the insurance provider database 118, and/or any other pre-configured external database. This allows the law enforcement officer to automatically determine a status of the vehicle and what, if any, action should be taken (e.g., the vehicle VIN 146 matches license plate 120 number as well as a make, model and color of the vehicle, or the VIN 146 does not match the license plate 120 number, or the VIN 146 corresponds to a stolen vehicle, etc.). The status of the vehicle VIN 146, and/or any recommended action, can be returned to the officer through visual cues provided on the display 128, through audio feedback via the internal speaker of the mobile device 124, and/or on an external audio device 130 connected to the mobile device 124 via Bluetooth, FireWire, and/or USB (e.g., ear buds). In some embodiments, a notification of the status of the vehicle VIN 146 is transmitted by the processor 130 over the network 102 to a dispatch portal 140.

Drivers License 122

A law enforcement officer equipped with the glasses 108, the body camera 106, and/or the camera 142 of the mobile device 124, captures a real-time photo of the driver, once the officer has pulled over the vehicle and is engaging the driver. The processor 130 then matches and/or compares the real-time photo against 1) a photo on the drivers license 122 (which was previously captured and analyzed by the processor 130) and/or 2) a photo retrieved over the network 102 from one or more external databases 112, such as the DMV database, the law enforcement vehicle database 116, the insurance provider database 118, and/or any other pre-configured external database. The processor 130 uses the comparison to determine a status of the driver (e.g., the comparison indicates a match between the real-time photo and the photo on the drivers license 122, or the real-time photo does not match the drivers license 122 photo, or the real-time photo is a person of concern, a felon, etc.). This allows a law enforcement officer to determine what, if any, action should be taken. The comparison may include performing a facial comparison of the real-time photo with the drivers license 122 photo. The status of the facial comparison, and/or any recommended action, can be returned to the officer visual cues provided on the display 128, through audio feedback via the internal speaker of the mobile device 124, and/or on an external audio device 130 connected to the mobile device 124 via Bluetooth, FireWire, and/or USB (e.g., ear buds). In some embodiments, a notification of the status of the facial comparison is transmitted by the processor 130 over the network 102 to a dispatch portal 140.

Vehicle Registration

A law enforcement officer equipped with the one or more input devices 104 (illustratively, the glasses 108, the body camera 106, and/or the camera 142 of the mobile device 124), captures an image and/or a video stream of a driver's vehicle registration, once the officer has pulled over the vehicle and is engaging the driver. The processor 130 detects and decodes one or more items of information from the vehicle registration using the captured image and/or the video stream. The processor 130 then initiates a look-up of the one or more items of information by accessing the one or more external databases 112 over the network 102. For example, the one or more external databases may comprise the DMV database, the law enforcement vehicle database 116, the insurance provider database 118, a database maintained by a municipality, county, or state, and/or any other pre-configured external database. The processor 130 receives one or more results of the look-up from the external database 112 over the network 102. The one or more results allow the law enforcement officer to determine a current status of the vehicle registration, and what (if any) action should be taken based upon the current status (for example, a citation may be issued due to the current status of the vehicle registration being expired). In some embodiments, the status of the vehicle registration and/or any recommended action can be returned to the law enforcement officer through visual cues provided on the mobile device 124, and/or through audible feedback via a speaker of the mobile device 124, and/or through any Bluetooth-connected audio device that is paired with the mobile device 124 (e.g., ear buds).

Real-Time Tracking and Reporting

In some embodiments, the processor 130 generates real-time telemetry and associated alerts. This provides an automatic over-watch capability in the event that the law enforcement officer needed assistance. (e.g., a noted felon, or a stolen car indication may automatically trigger a request for backup). These alerts may include, but are not limited, to tracking alerts, status alerts, audio analysis, and/or historic reporting. Tracking alerts can be generated by the processor 130 on a periodic or scheduled basis, and/or in response to a movement of the mobile device 124. The processor receives data from a global positioning system (GPS) 126 and a clock 132 of the mobile device 124 to transmit to the network 102 an exact date, time, location, and speed of the mobile device 124 of the law enforcement officer in real time. Similarly, status alerts are indicative of any movement of the mobile device 124 of the law enforcement officer. These status alerts may specify whether the law enforcement officer is stationary, running, or the speed at which they are traveling in their vehicle, etc.). The input devices 104 may include a vehicle impact sensor 110 which produces an indication in response to the law enforcement officer being involved in a collision.

In some embodiments, the one or more input devices 104 are equipped with streaming audio to allow the processor 130 to analyze audio interaction and determine appropriate conditions based on various conditions (e.g., officer confrontation, situation escalation, shots fired, etc.). For example, the memory 134 may include audio stream analysis software to provide this functionality.

In some embodiments, the processor 130 is capable of initiating a recording from the one or more input devices 104 of any/all video and audio interaction associated with an engagement between the law enforcement officer and one or more civilians. Recording can be initiated from the point of identifying the license plate 122 to the conclusion of the encounter, providing total chain of custody for evidentiary reporting.

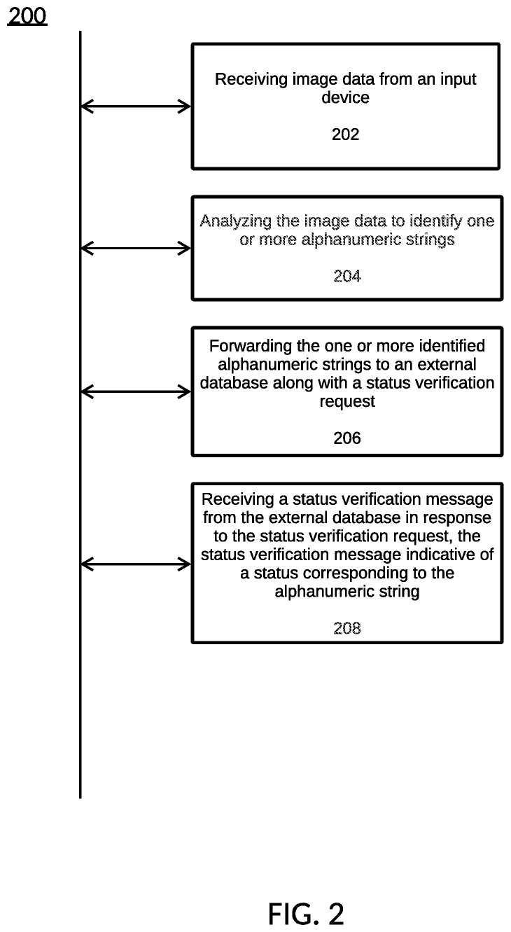

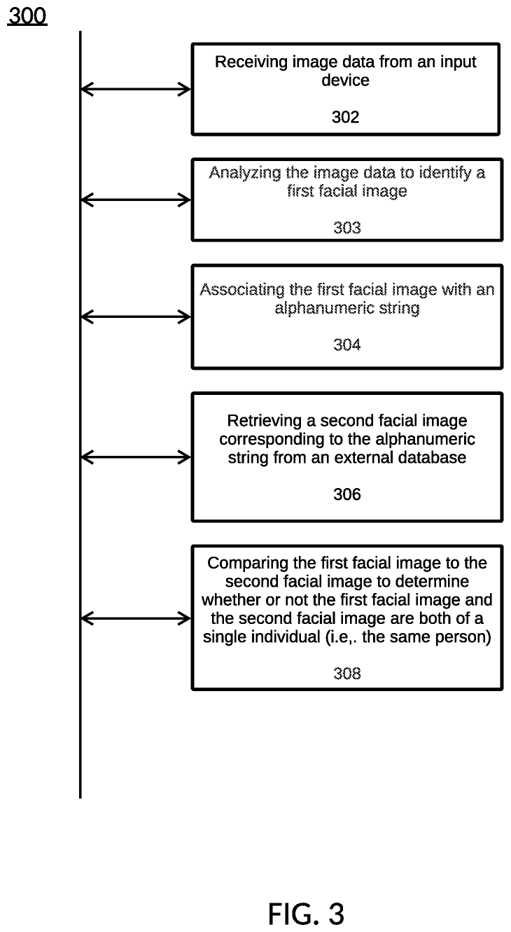

Flow diagrams depicted herein, such as FIG. 1, FIG. 2, and FIG. 3 are separate examples but may be the same or different embodiments. Any of the operations in one flow diagram could be adopted and shared with another flow diagram. No example operation is intended to limit the subject matter of any embodiment or corresponding claim.

It is important to note that all the flow diagrams and corresponding processes derived from FIG. 1, FIG. 2 and FIG. 3 may be part of a same process or may share sub-processes with one another thus making the diagrams combinable into a single preferred embodiment that does not require any one specific operation but which performs certain operations from one example process and from one or more additional processes. All the example processes are related to the same physical system and can be used separately or interchangeably.

FIG. 2 illustrates a flow diagram 200, according to a set of example embodiments. Referring to FIG. 2, the flow comprises receiving image data from an input device 202, analyzing the image data to identify one or more alphanumeric strings 204, forwarding the one or more identified alphanumeric strings to an external database along with a status verification request 206, and receiving a status verification message from the external database in response to the status verification request, the status verification message indicative of a status corresponding to the alphanumeric string 208.

FIG. 3 illustrates a flow diagram 300, according to another set of example embodiments. Referring to FIG. 3, the flow comprises receiving image data from an input device 302, analyzing the image data to identify a first facial image 303, associating the first facial image with an alphanumeric string 304, retrieving a second facial image corresponding to the alphanumeric string from an external database 306, and comparing the first facial image to the second facial image to determine whether or not the first facial image and the second facial image are both of a single individual 308.

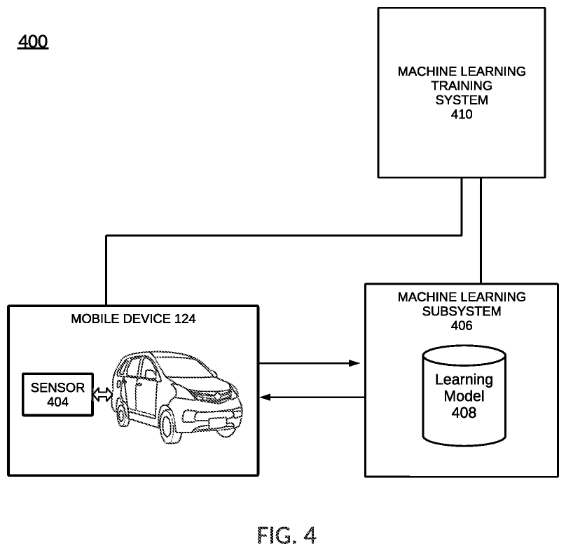

FIG. 4 illustrates a machine learning transport network diagram 400, according to example embodiments. The network 400 includes the mobile device 124 that interfaces with a machine learning subsystem 406. The mobile device 124 includes one or more sensors 404. In some embodiments, the one or more sensors 404 are on board the mobile device 124. In other embodiments, the one or more sensors 404 are external to the mobile device 124 and communicate with the mobile device 124 over a WiFi link, a Bluetooth link, a USB connection, a FireWire connection, or any of various combinations thereof.

The machine learning subsystem 406 contains a learning model 408, which is a mathematical artifact created by a machine learning training system 410 that generates predictions by finding patterns in one or more training data sets. In some embodiments, the machine learning subsystem 406 resides in the mobile device 124. In other embodiments, the machine learning subsystem 406 resides outside of the mobile device 124.

The mobile device 124 sends data from the one or more sensors 404 to the machine learning subsystem 406. The machine learning subsystem 406 provides the one or more sensor 404 data to the learning model 408, which returns one or more predictions. The machine learning subsystem 406 sends one or more instructions to the mobile device 124 based on the predictions from the learning model 408.

In a further embodiment, the mobile device 124 may send the one or more sensor 404 data to the machine learning training system 410. In yet another example, the machine learning subsystem 406 may sent the sensor 404 data to the machine learning subsystem 410. One or more of the applications, features, steps, solutions, etc., described and/or depicted herein may utilize the machine learning network 400 as described herein.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

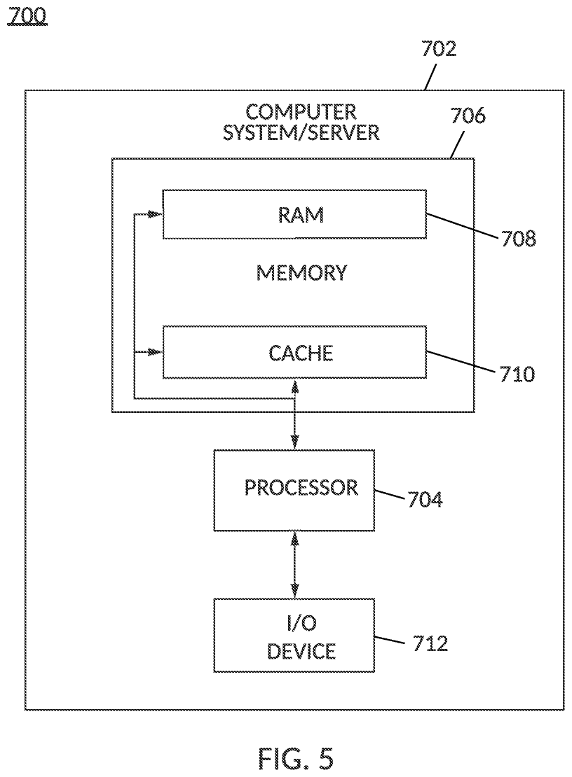

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 5 illustrates an example computer system architecture 700, which may represent or be integrated in any of the above-described components, etc.

FIG. 5 is not intended to suggest any limitation as to the scope of use or functionality of embodiments of the application described herein. Regardless, the computing node 700 is capable of being implemented and/or performing any of the functionality set forth hereinabove.

In computing node 700 there is a computer system/server 702, which is operational with numerous other general purpose or special purpose computing system environments or configurations. Examples of well-known computing systems, environments, and/or configurations that may be suitable for use with computer system/server 702 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 702 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 702 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 702 in cloud computing node 700 is shown in the form of a general-purpose computing device. The components of computer system/server 702 may include, but are not limited to, one or more processors or processing units 704, a system memory 706, and a bus that couples various system components including system memory 706 to processor 704.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 702 typically includes a variety of computer system readable media. Such media may be any available media that is accessible by computer system/server 702, and it includes both volatile and non-volatile media, removable and non-removable media. System memory 706, in one example, implements the flow diagrams of the other figures. The system memory 706 can include computer system readable media in the form of volatile memory, such as random-access memory (RAM) 708 and/or cache memory 710. Computer system/server 702 may further include other removable/non-removable, volatile/non-volatile computer system storage media. By way of example only, memory 706 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 706 may include at least one program product having a set (e.g., at least one) of program modules that are configured to carry out the functions of various embodiments of the application.

Program/utility, having a set (at least one) of program modules, may be stored in memory 706 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 702 may also communicate with one or more external devices via an I/O device 712 (such as an I/O adapter), which may include a keyboard, a pointing device, a display, a voice recognition module, etc., one or more devices that enable a user to interact with computer system/server 702, and/or any devices (e.g., network card, modem, etc.) that enable computer system/server 702 to communicate with one or more other computing devices. Such communication can occur via I/O interfaces of the device 712. Still yet, computer system/server 702 can communicate with one or more networks such as a local area network (LAN), a general wide area network (WAN), and/or a public network (e.g., the Internet) via a network adapter. As depicted, device 712 communicates with the other components of computer system/server 702 via a bus. It should be understood that although not shown, other hardware and/or software components could be used in conjunction with computer system/server 702. Examples, include, but are not limited to: microcode, device drivers, redundant processing units, external disk drive arrays, RAID systems, tape drives, and data archival storage systems, etc.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations that when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method, comprising:
receiving image data from an input device;
analyzing the image data to identify one or more alphanumeric strings;
forwarding the one or more alphanumeric strings to an external database, along with a status verification request; and
receiving a status verification message from the external database in response to the status verification request, the status verification message indicative of a status corresponding to the alphanumeric string.

2. The method of claim 1, further comprising acquiring the one or more alphanumeric strings from a drivers license, wherein the one or more alphanumeric strings comprise one or more of:
a name, an address, a birthdate, a weight, a height, a hair color, an eye color, or a drivers license number.

3. The method of claim 1, wherein the received status verification message indicates a status of a drivers license comprising one of valid, expired, suspended, or not valid.

4. The method of claim 1, further comprising acquiring the one or more alphanumeric strings from an insurance card, wherein the one or more alphanumeric strings comprise one or more of:
a name, an address, an insurance policy identification number, or an insurance company name.

5. The method of claim 1, wherein the received status verification message indicates a status of an insurance card comprising one of valid, expired, suspended, or not valid.

6. The method of claim 1, further comprising acquiring the one or more alphanumeric strings from a vehicle VIN number.

7. The method of claim 1, wherein the received status verification message indicates a status of a vehicle VIN number comprising one of valid, not valid, or stolen.

8. A method, comprising:
receiving image data from an input device;
analyzing the image data to identify a first facial image;
associating the first facial image with an alphanumeric string;
retrieving a second facial image corresponding to the alphanumeric string from an external database; and
comparing the first facial image to the second facial image to determine whether or not the first facial image and the second facial image are both of a single individual.

9. A system including a memory communicably coupled to a processor, wherein the processor is configured to:
receive image data from an input device;
analyze the image data to identify one or more alphanumeric strings;
forward the one or more alphanumeric strings to an external database, along with a status verification request; and
receive a status verification message from the external database in response to the status verification request, the status verification message indicative of a status corresponding to the alphanumeric string.

10. The system of claim 9, wherein the processor is further configured to acquire the one or more alphanumeric strings from a drivers license, wherein the one or more alphanumeric strings comprise one or more of:
a name, an address, a birthdate, a weight, a height, a hair color, an eye color, or a drivers license number.

11. The system of claim 9, wherein the received status verification message indicates a status of a drivers license comprising one of valid, expired, suspended, or not valid.

12. The system of claim 9, wherein the processor is further configured to acquire the one or more alphanumeric strings from an insurance card, wherein the one or more alphanumeric strings comprise one or more of:
a name, an address, an insurance policy identification number, or an insurance company name.

13. The system of claim 9, wherein the received status verification message indicates a status of an insurance card comprising one of valid, expired, suspended, or not valid.

14. The system of claim 9, wherein the processor is further configured to acquire the one or more alphanumeric strings from a vehicle VIN number.

15. The system of claim 9, wherein the received status verification message indicates a status of a vehicle VIN number comprising one of valid, not valid, or stolen.

16. A system including a memory communicably coupled to a processor, wherein the processor is configured to:
receive image data from an input device;
analyze the image data to identify a first facial image;
associate the first facial image with an alphanumeric string;
retrieve a second facial image corresponding to the alphanumeric string from an external database; and
compare the first facial image to the second facial image to determine whether or not the first facial image and the second facial image are both of a single individual.

17. A computer-readable storage medium comprising instructions that, when read by a processor, cause the processor to perform:
receiving image data from an input device;
analyzing the image data to identify one or more alphanumeric strings;
forwarding the one or more alphanumeric strings to an external database, along with a status verification request; and
receiving a status verification message from the external database in response to the status verification request, the status verification message indicative of a status corresponding to the alphanumeric string.

18. The computer-readable storage medium of claim 17, further comprising instructions for:
acquiring the one or more alphanumeric strings from a drivers license, wherein the one or more alphanumeric strings comprise one or more of:
a name, an address, a birthdate, a weight, a height, a hair color, an eye color, or a drivers license number.

19. The computer-readable storage medium of claim 17, wherein the received status verification message indicates a status of a drivers license comprising one of valid, expired, suspended, or not valid.

20. The computer-readable storage medium of claim 17, further comprising instructions for acquiring the one or more alphanumeric strings from an insurance card, wherein the one or more alphanumeric strings comprise one or more of:
a name, an address, an insurance policy identification number, or an insurance company name.
